(19) United States
(12) Patent Application Publication
(10) Pub. No.: US 2005/0053768 A1
(43) Pub. Date: Mar. 10, 2005

(54) Surface protection coating for glass sheets

(76) Inventors: Thomas J. Friedman, Danville, KY (US); Hongkyu Kim, Old Bridge, NJ (US); Teresa C. Nolet, Danville, KY (US)

Correspondence Address: CORNING INCORPORATED, SP-TI-3-1, CORNING, NY, 14831, US

(21) Appl. No.: 10/656,686

(22) Filed: Sep. 4, 2003

(51) Int. Cl. B32B 3/30; B32B 17/10

(52) U.S. Cl. 428/167; 206/454; 428/430; 428/442

(57) ABSTRACT

A method is described herein for packaging a plurality of glass sheets by: (1) coating a top surface of each glass sheet with a removable top protective film; (2) coating a bottom surface of each glass sheet with a removable bottom protective film; and (3) stacking the coated glass sheets next to one another such that the top protective film of one glass sheet is adjacent to the bottom protective film of another glass sheet. The top protective film and/or bottom protective film on each glass sheet has embossed features (e.g., rough features) formed therein which make it easier to separate one glass sheet from one another glass sheet because of the presence of air pockets caused by the embossed features located between the stacked glass sheets. The coated glass sheet and a container that can store a plurality of the coated glass sheets are also described herein.

### BACKGROUND OF THE INVENTION

1. Field of the Invention

The present invention relates to surface protection coatings that are applied to glass sheets (e.g., glass substrates) to protect the glass sheets and make it easier to package and unpackage the glass sheets.

2. Description of Related Art

One of the greatest challenges for a glass manufacturer today is coming-up with an effective way to protect and package glass sheets like the ones used in a liquid crystal display (LCD) so they can be safely transported to customers and easily unpacked by customers. Today one of the most common methods for packaging glass sheets includes coating the top/bottom surfaces of the glass sheets with a protective film (e.g., polyolefin film) and then placing an interleaver (e.g., paper sheet) between the coated glass sheets. The interleaver makes it easier for a person/machine to separate or unpackage one coated glass sheet from another coated glass sheet located next to one another in a container. Unfortunately, the placing of the interleavers between the coated glass sheets during the packing step and then the removal of the interleavers from between the coated glass sheets during the unpacking step can require a complex interleaver removing system and can be time-consuming and labor intensive steps. However, if the interleaver was not used then the coated glass sheets would often stick together making it difficult for a person/machine to separate stacked coated glass sheets. Accordingly, there is a need for a new way to protect and package glass sheets without using interleavers so they can be safely transported to customers and easily unpacked by customers. This need and other needs are satisfied by the coated glass sheet, container and method of the present invention.

### BRIEF DESCRIPTION OF THE INVENTION

The present invention relates to a method for packaging a plurality of glass sheets by: (1) coating a top surface of each glass sheet with a removable top protective film; (2) coating a bottom surface of each glass sheet with a removable bottom protective film; and (3) stacking the coated glass sheets next to one another such that the top protective film of one glass sheet is adjacent to the bottom protective film of another glass sheet. The top protective film and/or bottom protective film on each glass sheet has embossed features (e.g., rough features) formed therein which make it easier to separate one glass sheet from one another glass sheet because of the presence of air pockets caused by the embossed features located between the stacked glass sheets. The present invention also relates to the coated glass sheet and a container that can store a plurality of the coated glass sheets.

### BRIEF DESCRIPTION OF THE DRAWINGS

A more complete understanding of the present invention may be had by reference to the following detailed description when taken in conjunction with the accompanying drawings wherein:

FIGS. 1A-1C are diagrams that respectively show a side view, top view and bottom view of a coated glass sheet in accordance with a first embodiment of the present invention;

FIG. 1D is a perspective view of an exemplary container capable of holding a set of the coated glass sheets shown in FIGS. 1A-1C;

FIGS. 2A-2C are diagrams that respectively show a side view, top view and bottom view of a coated glass sheet in accordance with a second embodiment of the present invention;

FIG. 2D is a perspective view of an exemplary container capable of holding a set of the coated glass sheets shown in FIGS. 2A-2C;

FIGS. 3A-3C are diagrams that respectively show a side view, top view and bottom view of a coated glass sheet in accordance with a third embodiment of the present invention;

FIG. 3D is a perspective view of an exemplary container capable of holding a set of the coated glass sheets shown in FIGS. 3A-3C;

FIGS. 4A-4C are diagrams that respectively show a side view, top view and bottom view of a coated glass sheet in accordance with a fourth embodiment of the present invention;

FIG. 4D is a perspective view of an exemplary container capable of holding a set of the coated glass sheets shown in FIGS. 4A-4C; and

FIG. 5 is a flowchart illustrating the basic steps in a method for packaging a plurality of glass sheets in accordance with the present invention.

### DETAILED DESCRIPTION OF THE DRAWINGS

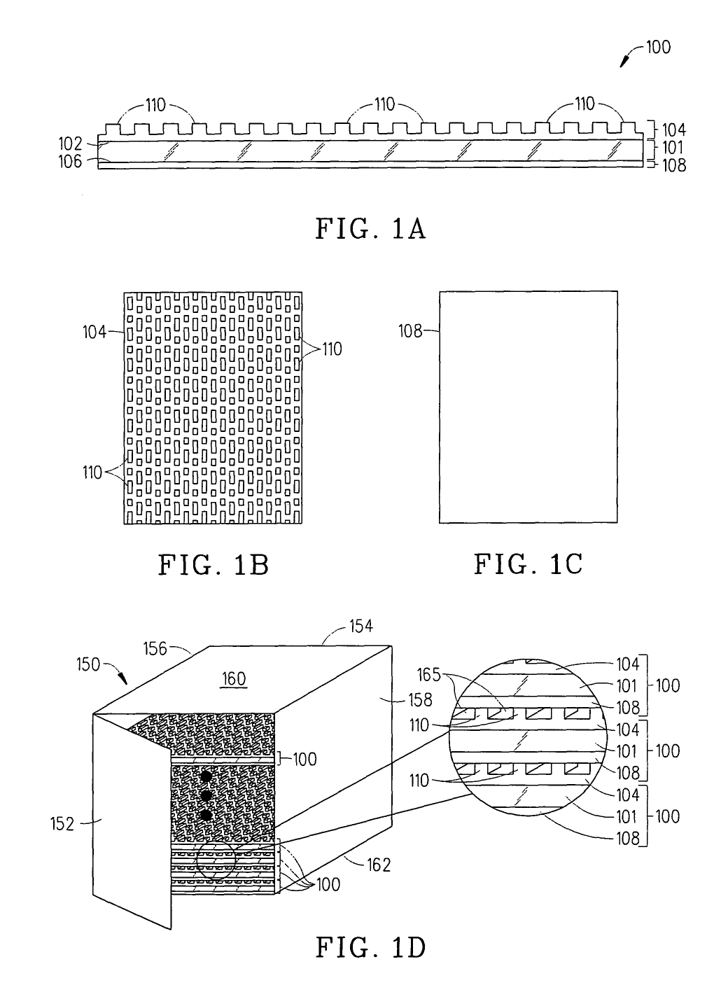

Referring to FIGS. 1A-1C, there are diagrams that respectively show a side view, top view and bottom view of a coated glass sheet 100 in accordance with a first embodiment of the present invention. The coated glass sheet 100 includes a glass sheet 101 that has a top surface 102 coated with a removable top protective film 104 (e.g., flexible polymer film 104, high density polyethylene film 104 or other polyolefin film 104) and a bottom surface 106 coated with a removable bottom protective film 108 (e.g., low density polyethylene film 108 or other polyolefin film 108). The top protective film 104 has at least one surface which has embossed features 110 (e.g., designed-in features 110, rough features 110) formed therein. As shown, the embossed features 110 are bumps or bulges but they could have any type of shape or configuration such as a channel. The embossed features 110 may be formed within the top protective film 104 by using an engraved roll during an extrusion casting process, coextrusion casting process or other film embossing process. The bottom protective film 108 has two flat surfaces which do not have embossed features 110. An advantage of using the top protective film 104 which has embossed features 110 formed therein to coat the glass sheet 101 is described below with respect to FIG. 1D.

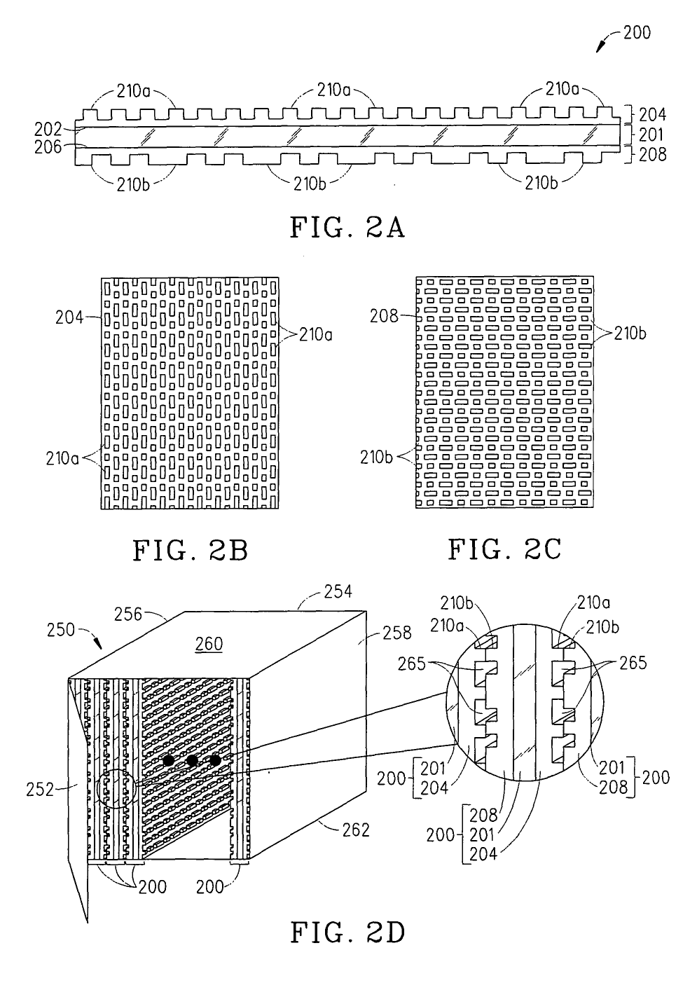

Referring to FIG. 1D, there is a perspective view of an exemplary container 150 capable of holding multiple stacked coated glass sheets 100. The container 150 includes a first side 152 (e.g., door 152), an opposing second side 154, two additional sides 156 and 158, a top 160 and a bottom 162. The container 150 can be sized to store any number of coated glass sheets 100. The coated glass sheets 100 are stacked or placed next to one another inside the container 150 such that the top protective film 104 of one glass sheet 100 is adjacent to the bottom protective film 108 of another glass sheet 100. An important aspect of the embossed features 110 is that they cause the formation of air pockets 165 (10˜500 micron, preferably less than 100 micron) between each pair of stacked coated glass sheets 100. The presence of the air pockets 165 is important because they enable air to flow between the embossed features 110 which makes it easy to separate one coated glass sheet 100 from an adjacent coated glass sheet 100. Although the container 150 is described herein as being used to horizontally stack multiple coated glass plates 100, it should be understood that the coated glass sheets 100 can be placed next to one another in a variety of positions including a vertical position or an angled position (see FIGS. 2D, 3D and 4D).

Referring to FIGS. 2A-2C, there are diagrams that respectively show a side view, top view and bottom view of a coated glass sheet 200 in accordance with a second embodiment of the present invention. The coated glass sheet 200 includes a glass sheet 201 that has top surface 202 coated with a removable top protective film 204 (e.g., flexible polymer film 204, high density polyethylene film 204 or other polyolefin film 204) and a bottom surface 206 coated with a removable bottom protective film 208 (e.g., low density polyethylene film 208 or other polyolefin film 208). The top protective film 204 has at least one surface which has embossed features 210a (e.g., designed-in features 210a, rough features 210a) formed therein. Likewise, the bottom protective film 208 has at least one surface which has embossed features 210b (e.g., designed-in features 210b, rough features 210b) formed therein. As shown, the embossed features 210a and 210b are typically bumps or bulges but they could have any type of shape or configuration such as a channel. The embossed features 210a and 210b may be formed within the top protective film 204 and the bottom protective film 208 by using an engraved roll during an extrusion casting process, coextrusion casting process or other film embossing process. An advantage of using the top protective film 204 and bottom protective film 208 which have embossed features 210a and 210b formed therein to coat the glass sheet 201 is described below with respect to FIG. 2D.

Referring to FIG. 2D, there is a perspective view of an exemplary container 250 capable of holding multiple stacked coated glass sheets 200. The container 250 includes a first side 252 (e.g., door 252), an opposing second side 254, two additional sides 256 and 258, a top 260 and a bottom 262. The container 250 can be sized to store any number of coated glass sheets 200. The coated glass sheets 200 are placed or stacked next to one another inside the container 250 such that the top protective film 204 of one glass sheet 200 is adjacent to the bottom protective film 208 of another glass sheet 200. As shown, the embossed features 210a on the top protective film 204 have a different shape than the embossed features 210b on the bottom protective film 208 (see FIGS. 2B and 2C). The different shapes between the embossed features 210a and 210b help prevent the interlocking of the top protective film 204 and the bottom protective film 208. An important aspect of the embossed features 210a and 210b is that they cause the formation of air pockets 265 (10˜500 micron, preferably less than 100 micron) between each pair of stacked coated glass sheets 200. The presence of the air pockets 265 is important because they enable air to flow between the embossed features 210a and 210b which makes it easy to separate one coated glass sheet 200 from an adjacent glass sheet 200. Although the container 250 is described herein as being used to vertically stack multiple coated glass plates 200, it should be understood that the coated glass sheets 200 can be placed next to one another in a variety of positions including a horizontal position or an angled position (see FIGS. 1D, 3D and 4D).

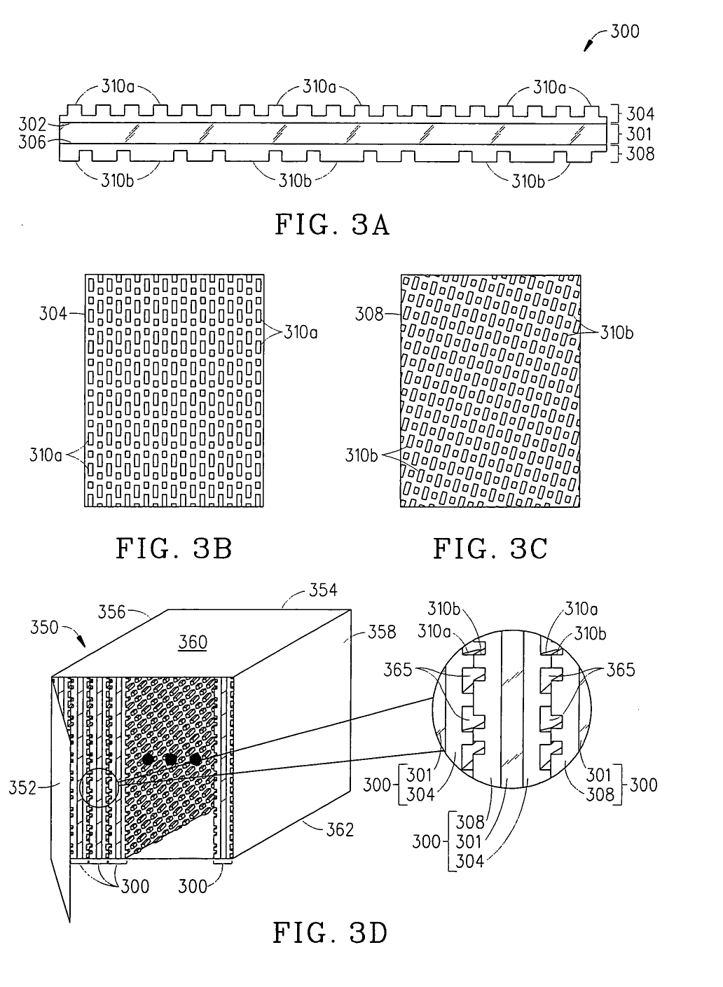

Referring to FIGS. 3A-3C, there are diagrams that respectively show a side view, top view and bottom view of a coated glass sheet 300 in accordance with a third embodiment of the present invention. The coated glass sheet 300 includes a glass sheet 301 that has top surface 302 coated with a removable top protective film 304 (e.g., flexible polymer film 304, high density polyethylene film 304 or other polyolefin film 304) and a bottom surface 306 coated with a removable bottom protective film 308 (e.g., low density polyethylene film 308 or other polyolefin film 308). The top protective film 304 has at least one surface which has embossed features 310a (e.g., designed-in features 310a, rough features 310a) formed therein. Likewise, the bottom protective film 308 has at least one surface which has embossed features 310b (e.g., designed-in features 310b, rough features 310b) formed therein. As shown, the embossed features 310a and 310b are typically bumps or bulges but they could have any type of shape or configuration such as a channel. The embossed features 310a and 310b may be formed within the top protective film 304 and the bottom protective film 308 by using an engraved roll during an extrusion casting process, coextrusion casting process or other film embossing process. An advantage of using the top protective film 304 and bottom protective film 308 which have embossed features 310a and 310b formed therein to coat the glass sheet 301 is described below with respect to FIG. 3D.

Referring to FIG. 3D, there is a perspective view of an exemplary container 350 capable of holding multiple coated glass sheets 300. The container 350 includes a first side 352 (e.g., door 352), an opposing second side 354, two additional sides 356 and 358, a top 360 and a bottom 362. The container 350 can be sized to store any number of coated glass sheets 300. The coated glass sheets 300 are placed or stacked next to one another inside the container 350 such that the top protective film 304 of one glass sheet 300 is adjacent to the bottom protective film 308 of another glass sheet 300. As shown, the embossed features 310a on the top protective film 304 are located in a slightly different position or angle than the embossed features 310b on the bottom protective film 308 (see FIGS. 3B and 3C). This difference between the embossed features 310a and 310b helps prevent the interlocking of the top protective film 304 and the bottom protective film 308. An important aspect of the embossed features 310a and 310b is that they cause the formation of air pockets 365 (10˜500 micron, preferably less than 100 micron) between each pair of stacked coated glass sheets 300. The presence of air pockets 365 is important because they enable air to flow between the embossed features 310a and 310b which makes it easy to separate one coated glass sheet 300 from an adjacent coated glass sheet 300. Although the container 350 is described herein as being used to vertically stack multiple coated glass plates 300, it should be understood that the coated glass sheets 300 can be placed next to one another in a variety of positions including a horizontal position or an angled position (see FIGS. 1D, 2D and 4D).

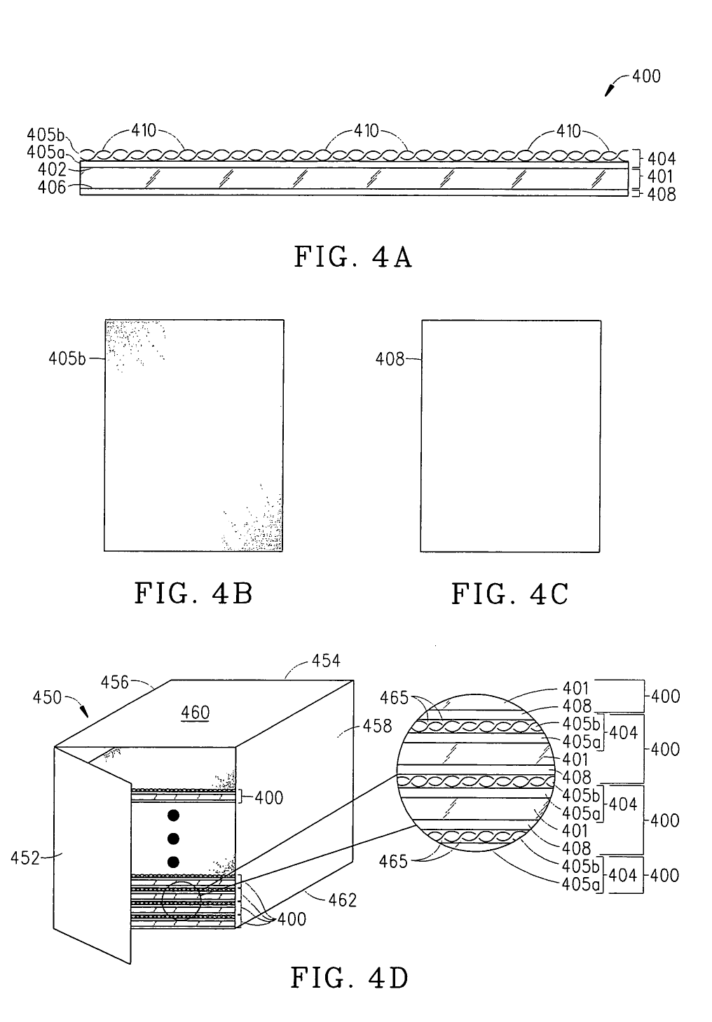

Referring to FIGS. 4A-4C, there are diagrams that respectively show a side view, top view and bottom view of a coated glass sheet 400 in accordance with a fourth embodiment of the present invention. The coated glass sheet 400 includes a glass sheet 401 that has top surface 402 coated with a removable top protective film 404 and a bottom surface 406 coated with a removable bottom protective film 408. The top protective film 404 is a multi-layer structure that has a smooth layer 405a and a rough layer 405b. The rough layer 405b has embossed features 410. In one embodiment, the smooth layer 405a is a polymer film and the rough layer 405b is a non-woven fabric, woven fabric or paper. In this example, the top protective film 404 can be made by feeding and applying the rough layer 405b (e.g., non-woven fabric, woven fabric, paper) onto the smooth layer 405a (e.g., polymer film) while casting the smooth layer 405a. Or, the top protective film 404 can be made by laminating two polymer films by using an adhesive or thermal process. The bottom protective film 408 (e.g., low density polyethylene film 408 or other polyolefin film 408) can have two surfaces which do not have embossed features 410 (as shown). Or, the bottom protective film 408 (e.g., low density polyethylene film 408 or other polyolefin film 408) can have two surfaces which do have embossed features 410 (not shown). Alternatively, the bottom protective film 408 can have a multi-layer structure that has a smooth layer and a rough layer (not shown). An advantage of using the top protective film 404 which has the smooth layer 405a and the rough layer 405b to coat the glass sheet 401 is described below with respect to FIG. 4D.

Referring to FIG. 4D, there is a perspective view of an exemplary container 450 capable of holding multiple stacked coated glass sheets 400. The container 450 includes a first side 452 (e.g., door 452), an opposing second side 454, two additional sides 456 and 458, a top 460 and a bottom 462. The container 450 can be sized to store any number of coated glass sheets 400. The coated glass sheets 400 are placed or stacked next to one another inside the container 450 such that the top protective film 404 of one glass sheet 400 is adjacent to the bottom protective film 408 of another glass sheet 400. The top protective film 404 has a rough layer 405b which causes the formation of air pockets 465 between each pair of stacked coated glass sheets 400. The presence of air pockets 465 is important because they enable air to flow between the embossed features 410 in the rough layer 405b which makes it easy to separate one glass sheet 400 from an adjacent coated glass sheet 400. Although the container 450 is described herein as being used to stack in a horizontal position multiple coated glass plates 400, it should be understood that the coated glass sheets 400 can be placed next to one another in a variety of positions including a vertical position or an angled position (see FIGS. 1D, 2D and 3D).

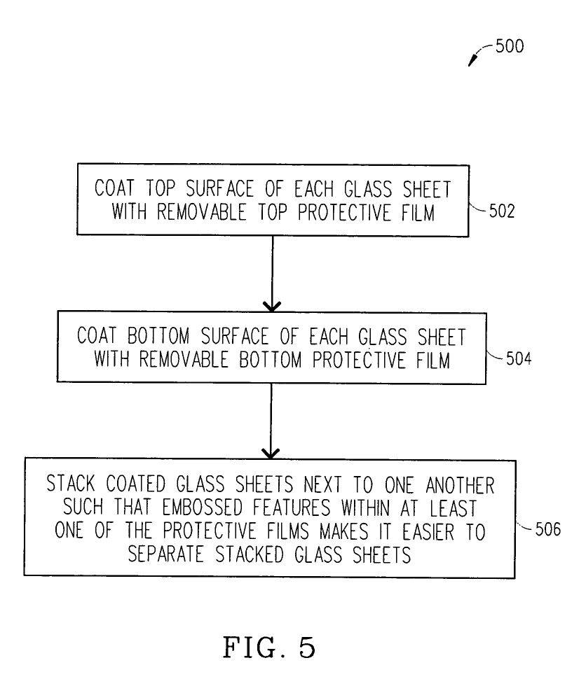

Referring to FIG. 5, there is a flowchart illustrating the basic steps in a method 500 for packaging a plurality of glass sheets in accordance with the present invention. For clarity, the method 500 is described below with respect to using the first embodiment of the coated glass sheets 100 (see FIGS. 1A-1D). However, it should be understood that the method 500 can also be performed using the other embodiments of the coated glass sheets 200, 300 and 400 (see FIGS. 2-4). Beginning at step 502, each glass sheet 101 has a top surface 102 that is coated with a removable top protective film 104 (e.g., flexible polymer film 104, high density polyethylene film 104 or other polyolefin film 104). At step 504, each glass sheet 101 has a bottom surface 106 that is coated with a removable bottom protective film 104 (e.g., low density polyethylene film 108 or other polyolefin film 108) (see FIGS. 1A-1C) It should be appreciated that steps 502 and 504 can be accomplished simultaneously. At step 506, the coated glass sheets 100 are placed or stacked next to one another in a container 150 such that the top protective film 104 of one coated glass sheet 100 is adjacent to the bottom protective film 108 of another coated glass sheet 100 (see FIG. 1D). As described above, the top protective film 104 and/or bottom protective film 108 have embossed features 110 (e.g., rough features 110) formed therein which make it easier to separate one coated glass sheet 100 from another coated glass sheet 100 because of the presence of air pockets 165 caused by the embossed features 110 located between the stacked glass sheets 100.

Following are some advantages and features of the coated glass sheets 100, 200, 300 and 400 and method 500 of the present invention:
The present invention significantly reduces the complexity of the coating and packing operations at the glass sheet coating/packaging stage and also reduces the complexity of the unpacking operation at unloading stage. The traditional coating/packaging stage involved two operations: (1) the placing of surface protection films on the glass sheet; and (2) the laying of a paper interleaver on the coated glass sheet. With the present invention, the step of laying the paper interleaver on the coated glass sheet can be eliminated in the coating/packing stage. The present invention also eliminates the need to remove the paper interleaver in the unpacking stage. Thus, the present invention eliminates the labor and capital costs associated with laying and removing the paper interleaver from between the coated glass sheets.
The containers 150, 250, 350 and 450 can have a wide range of configurations and can hold any number of glass sheets. For example, the containers 150, 250, 350 and 450 can contain 300-500 pieces of unfinished coated glass sheets and 20-30 pieces of finished glass sheets. The finished glass sheets typically have the following dimensions:
   Gen 3 glass—550×650˜590×670 (mm)
   Gen 4 glass—680x880˜730×920 (mm)
   Gen 5 glass—1000x1200˜1200×1300 (mm)
   Gen 6 glass—1500x1820 (mm)
   Gen 7 glass—1680x1820 (mm)
The glass sheet/glass substrate can be any type of sheet including, for example, a LCD glass substrate, a glass blank, a plasma glass substrate, a fluorescent display tube glass substrate, a thermal head glass substrate or a color filter. And, the LCD glass substrate can have an additional functionality, for example, amorphous silicon layer or polycrystalline silicon layer.
It should be appreciated that there are numerous processing methods that can be used to laminate two or multiple layers of different films to make the top/bottom protective films. For example, the top/bottom protective films could be made by laminating multiple films by feeding these films between a heating roll (could also be embossing roll) or applying adhesive on layers before feeding the films through a pressure roll (could also be embossing roll). Other methods include using multilayer extrusion casting process where different polymer resins can be melt-extruded and cast on a roll (could be an embossing roll) or a steel belt (could be an embossing belt) through an extrusion dies which shapes the film geometry.
It should be appreciated that the top/bottom protective film also protects the glass sheet in a manner that prevents scratches, stains, dirt and other contaminants from damaging the surfaces of the glass sheets.
It should be appreciated that an external layer of the top/bottom protective film can have a harder surface (higher modulus or high stiffness) than the layer that contacts the glass sheet. The harder external layer in addition to the embossed features can make it easier to separate coated glass sheets.

Although several embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims.

1. A glass sheet comprising:
a top surface coated with a removable top protective film; and
a bottom surface coated with a removable bottom protective film, wherein at least one of the top protective film and bottom protective film has embossed features formed therein.

2. The glass sheet of claim 1, wherein said top protective film has embossed features and said bottom protective film does not have embossed features.

3. The glass sheet of claim 2, wherein said top protective film is a multi-layer structure that has a smooth layer and a rough layer.

4. The glass sheet of claim 3, wherein said smooth layer is a polymer film and said rough layer is a layer of fabric or paper.

5. The glass sheet of claim 3, wherein said smooth layer has a modulus of stiffness that is lower than a modulus of stiffness of said rough layer.

6. The glass sheet of claim 1, wherein said top protective film has embossed features and said bottom protective film has embossed features.

7. The glass sheet of claim 6, wherein the embossed features on said top protective film have a different shape or are located in a different position than the embossed features on said bottom protective film.

8. The glass sheet of claim 6, wherein at least one of said top protective film and said bottom protective film is a multi-layer structure that has a smooth layer and a rough layer.

9. The glass sheet of claim 8, wherein said smooth layer is a polymer film and said rough layer is a layer of fabric or paper.

10. The glass sheet of claim 8, wherein said smooth layer has a modulus of stiffness that is lower than a modulus of stiffness of said rough layer.

11. A method for packaging a plurality of glass substrates, said method comprising the steps of:
coating a top surface of each glass substrate with a removable top protective film;
coating a bottom surface of each glass substrate with a removable bottom protective film; and
stacking the glass substrates next to one another such that the top protective film of one glass substrate is adjacent to the bottom protective film of another glass substrate, wherein at least one of the top protective film and bottom protective film on each glass substrate has designed-in features which make it easier to separate one glass substrate from another glass substrate because of the presence of air pockets caused by the designed-in features located between said stacked glass substrates.

12. The method of claim 11, wherein said glass substrates are stacked next to one another in a vertical position within a container.

13. The method of claim 11, wherein said glass substrates are stacked next to one another in a horizontal position within a container.

14. The method of claim 11, wherein said glass substrates are stacked next to one another in a predetermined angle from a vertical position within a container.

15. The method of claim 11, wherein said top protective film has designed-in features and said bottom protective film does not have designed-in features.

16. The method of claim 11, wherein said top protective film has one type of designed-in features and said bottom protective film has a second type of designed-in features.

17. A container for holding a plurality of glass sheets, said container comprising:
a first side;
an opposing second side;
two additional sides;
a top; and
a bottom all of which enclose said glass sheets, each glass sheet includes:
a top surface coated with a removable top protective film; and
a bottom surface coated with a removable bottom protective film, wherein the glass sheets are stacked next to one another such that the top protective film of one glass sheet is adjacent to the bottom protective film of another glass sheet, wherein at least one of the top protective film and bottom protective film on each glass sheet has embossed features therein which make it easier to separate one glass sheet from another glass sheet because of the presence of air pockets caused by the embossed features located between said stacked glass sheets.

18. The container of claim 17, wherein said top protective film has embossed features and said bottom protective film does not have embossed features.

19. The container of claim 17, wherein said top protective film has one type of embossed features and said bottom protective film has a second type of embossed features.

20. The container of claim 17, wherein said top protective film is made from a high density polyethylene film other flexible polymer film and said bottom protective film is made from a low density polyethylene film other polyolefin film.

21. The container of claim 17, wherein said glass sheet is used in a liquid crystal display.

22. A material comprising:
a top surface coated with a removable top protective film; and
a bottom surface coated with a removable bottom protective film, wherein at least one of the top protective film and bottom protective film has embossed features therein which make it easier to separate said material that is stacked on another piece of material because of the presence of air pockets caused by the embossed features located between said stacked materials.

23. The material of claim 22, wherein said top protective film has embossed features and said bottom protective film does not have embossed features.

24. The material of claim 22, wherein said top protective film has one type of embossed features and said bottom protective film has a second type of embossed features.
